(19) United States
(12) Patent Application Publication
(10) Pub. No.: US 2010/0163002 A1
(43) Pub. Date: Jul. 1, 2010

(54) VARIABLE COMPRESSION RATIO INTERNAL COMBUSTION ENGINE

(75) Inventor: Eiichi Kamiyama, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 12/664,266

(22) PCT Filed: Jun. 11, 2008
(86) PCT No.: PCT/JP08/61076

§ 371 Date: Dec. 11, 2009

(30) Foreign Application Priority Data
Jun. 13, 2007 (JP) 2007-156172

(51) Int. Cl. F02B 75/04; F02M 35/02

(52) U.S. Cl. 123/48 C; 123/198 E

(57) ABSTRACT

An internal combustion engine 10 comprises a device having a mechanism that moves a cylinder block relative to a crankcase, a worm wheel (wheel) 54 fixed to the mechanism, and a worm 55 meshed with the wheel. The device is disposed at the position in the vicinity of an disposed-face OS1 and within the OS3 disposed-face when the disposed-face is viewed from the front. The internal combustion engine drives the worm for rotatably driving the wheel to drive the mechanism. The internal combustion engine has a noise shielding members 61, 62, and 83 arranged so as to cover a meshing portion EG where the wheel and the worm are meshed with each other, when the disposed-face is viewed from the front. The noise generated at the meshing portion is attenuated by the noise shielding member, and propagated to the outside of the internal combustion engine. Consequently, the noise heard at the outside is reduced.

### BACKGROUND OF THE INVENTION

1. Technical Field

The present invention relates to a variable compression ratio internal combustion engine capable of changing a compression ratio that is a ratio of a maximum value to a minimum value of a volume of a combustion chamber, the volume changing with a reciprocal movement of a piston.

2. Background Art

A variable compression ratio internal combustion engine that can change a compression ratio has been conventionally known. The variable compression ratio internal combustion engine includes a compression ratio changing mechanism that is driven for moving a cylinder block relative to a crankcase in a direction of a center axis of a cylinder bore, a gear mechanism having a pair of gears that are meshed with each other, and a drive device for driving the gear mechanism. The gear mechanism is driven to drive the compression ratio changing mechanism. With this structure, when the gear mechanism is driven by the drive device, the cylinder block is moved relative to the crankcase, so that the compression ratio is changed (e.g., see Japanese Patent Application Laid-Open (kokai) No. 2006-283730).

In a state in which the gear mechanism is driven, coarse large sound (noise) such as gear noise and clattering noise may be generated in some cases at a mesh section where the pair of gears are meshed with each other and at the compression ratio changing mechanism.

As described above, the conventional variable compression ratio internal combustion engine entails a problem of generating noise at the meshing section. Further, this problem may occur when a different power transmission mechanism, such as a belt mechanism or the like, instead of the gear mechanism is used.

### DISCLOSURE OF THE INVENTION

The present invention is made in view of the aforesaid problem. The object of the invention is to provide a variable compression ratio internal combustion engine that can reduce noise which is heard at the outside of the variable compression ratio internal combustion engine.

In order to accomplish the foregoing object, a variable compression ratio internal combustion engine according to the present invention comprises,

a compression ratio changing mechanism that is driven to change a compression ratio of the engine;

driving means including a power transmission mechanism and a power source that drives the power transmission mechanism, the power transmission mechanism being driven to drive the compression ratio changing mechanism, the power transmission mechanism being disposed at a position in the vicinity of a mechanism-disposed-face which is composed of at least one of a side wall face of a cylinder block and a side wall face of a crankcase, and the power transmission mechanism being arranged within the mechanism-disposed-face (within end portions that define the mechanism-disposed-face) when the mechanism-disposed-face is viewed from the front; and

a noise shielding member that is arranged so as to cover at least a part of the power transmission mechanism, when the mechanism-disposed-face is viewed from the front.

With this configuration, at least a part of the power transmission mechanism is covered by the noise shielding member, when the mechanism-disposed-face is viewed from the front. Accordingly, the noise generated by the power transmission mechanism is attenuated by the noise shielding member, and propagated to the outside of the variable compression ratio internal combustion engine. As a result, the noise that can be heard at the outside of the variable compression ratio internal combustion engine is reduced, compared to the case in which the power transmission mechanism is not covered by the noise shielding member.

In this case, it is preferable that the compression ratio changing mechanism be configured to change the compression ratio by moving either one of the cylinder block and the crankcase relative to the other.

In this case, it is preferable that the power transmission mechanism include a pair of gears that are meshed with each other; and the noise shielding member be disposed (arranged) so as to cover a meshing portion where the pair of gears mesh with each other, when the mechanism-disposed-face is viewed from the front.

When the power transmission mechanism comprises the gear mechanism including a pair of gears, relatively large noise is generated at the meshing portion where the pair of gears are meshed with each other. Therefore, if the meshing portion is covered by the noise shielding member when the mechanism-disposed-face is viewed from the front, the noise that can be heard at the outside of the variable compression ratio internal combustion engine can surely be reduced.

In this case, it is preferable that the noise shielding member be configured to cover, when the mechanism-disposed-face is viewed from the front, the whole of the power transmission mechanism and the compression ratio changing mechanism.

With this configuration, the whole of the power transmission mechanism and the compression ratio changing mechanism is covered by the noise shielding member. Therefore, the noise generated at the power transmission mechanism and the compression ratio changing mechanism is also attenuated by the noise shielding member. As a result, the noise that can be heard at the outside of the variable compression ratio internal combustion engine is reduced, compared to the case in which the whole of the power transmission mechanism is not covered by the noise shielding member.

In this case, it is preferable that the noise shielding member include at least one of an intake-system-constructing-member that constructs an intake system for introducing air into the variable compression ratio internal combustion engine, an exhaust-system-constructing-member that constructs an exhaust system for exhausting exhaust gas from the variable compression ratio internal combustion engine, and accessories that are devices configured to be capable of being driven by an output shaft of the variable compression ratio internal combustion engine.

In this case, it is preferable that the noise shielding member include a designed cover (or an ornamental cover) that covers, when the intake-system-constructing-member and the mechanism-disposed-face are viewed from the front, at least a part of the intake-system-constructing-member.

In this case, it is preferable that the noise shielding member include a heat-insulating cover that covers, when the exhaust-system-constructing-member and the mechanism-disposed-face are viewed from the front, at least a part of the exhaust-system-constructing-member.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a front view of an internal combustion engine according to an embodiment of the present invention;

FIG. 2 is a side view of the internal combustion engine shown in FIG. 1;

FIG. 3 is a side view of the internal combustion engine shown in FIG. 1;

FIG. 4 is a perspective view of an engine main body shown in FIG. 1;

FIG. 5 is an exploded perspective view showing a part of the engine main body shown in FIG. 1;

FIG. 6 is a perspective view of the cylinder block shown in FIG. 1;

FIG. 7 is a sectional view of the engine main body cut at a plane along a 7-7 line shown in FIG. 5;

FIG. 8 is a side view of the internal combustion engine when a designed cover is removed;

FIG. 9 is a side view of the internal combustion engine when a heat-insulating cover is removed;

FIG. 10 is a conceptual view showing the operation of the compression ratio changing mechanism shown in FIG. 7;

FIG. 11 is a diagram schematically showing a force applied to the compression ratio changing device when the combustion occurs in the combustion chamber shown in FIG. 7; and

FIG. 12 is a side view of an internal combustion engine according to a modification of the present invention.

### BEST MODE FOR CARRYING OUT THE INVENTION

### Construction

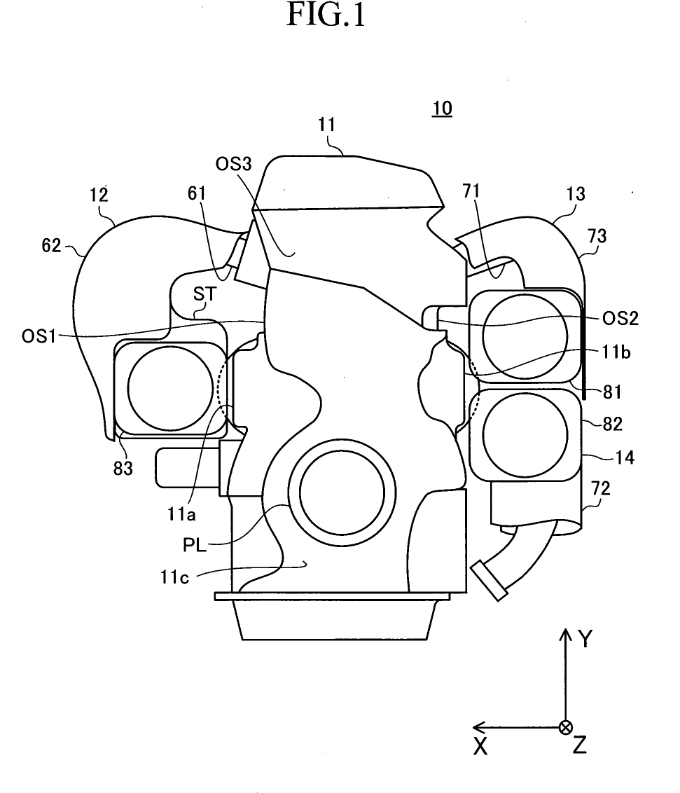

An embodiment of the variable compression ratio internal combustion engine according to the present invention will be described below with reference to FIGS. 1 to 3. As shown in FIGS. 1 to 3, the variable compression ratio internal combustion engine (internal combustion engine) 10 includes an engine main body 11, and an intake-system-constructing-section 12, an exhaust-system-constructing-section 13 and accessories section 14, these being fixed to the engine main body 11. The description is provided below using a rectangular coordinate with a right-hand system having an X-axis, Y-axis and Z-axis.

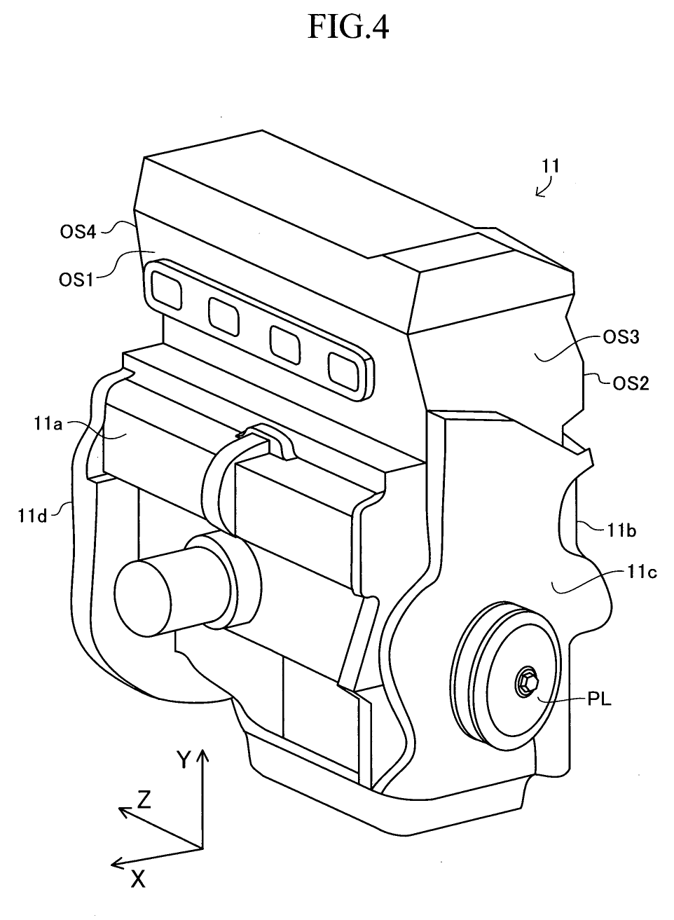

The engine main body 11 has generally a rectangular shape having four sidewall faces OS1 to OS4 as shown in FIG. 4 that illustrates the engine main body 11 of the internal combustion engine 10 from which the intake-system-constructing-section 12, the exhaust-system-constructing-section 13 and the accessories section 14 are removed (specifically, FIG. 4 illustrates only the engine main body 11).

The sidewall face OS1 is a sidewall face perpendicular to the X-axis and located at the side of a positive direction of the X-axis. The sidewall face OS1 is referred to as a left sidewall face OS1. Further, the left sidewall face OS1 is also referred to as a mechanism-disposed-face OS1.

The sidewall face OS2 is a sidewall face perpendicular to the X-axis and located at the side of a negative direction of the X-axis. The sidewall face OS2 is referred to as a right sidewall face OS2. Further, the right sidewall face OS2 is also referred to as a mechanism-disposed-face OS2.

The sidewall face OS3 is a sidewall face perpendicular to the Z-axis and located at the side of a negative direction of the Z-axis. The sidewall face OS3 is referred to as a front sidewall face OS3. The sidewall face OS4 is a sidewall face perpendicular to the Z-axis and located at the side of a positive direction of the Z-axis. The sidewall face OS4 is also referred to as a rear sidewall face OS4.

The engine main body 11 comprises cover members 11a to 11d corresponding respectively to the sidewall faces OS1 to OS4. The cover members 11a to 11d are fixed to the engine main body 11 so as to cover a part of the corresponding sidewall faces OS1 to OS4.

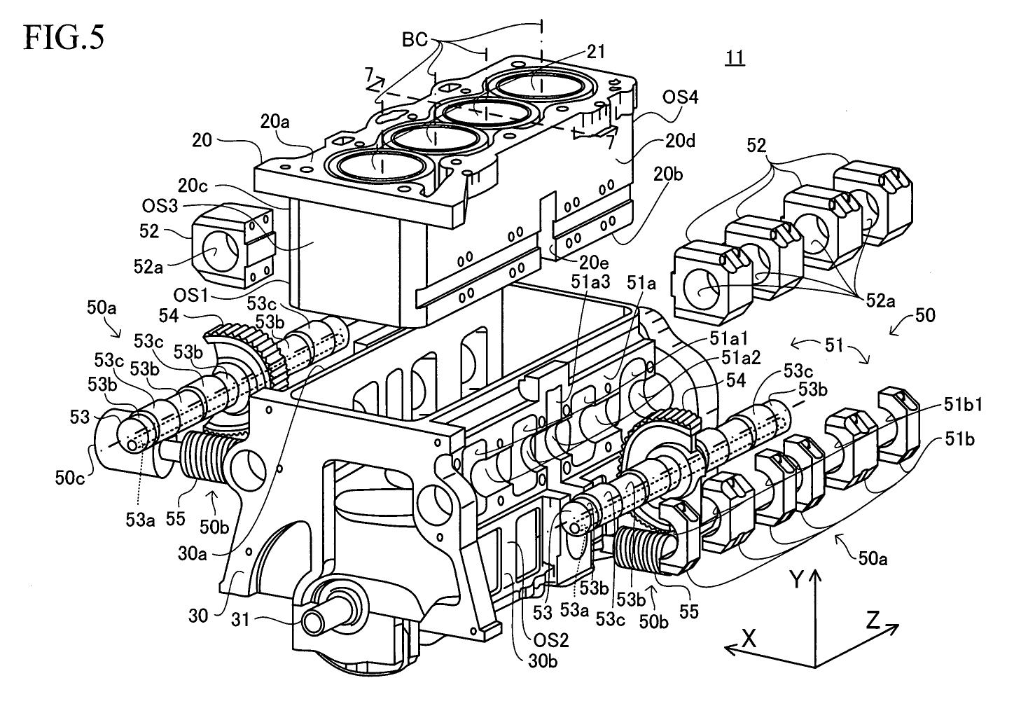

The engine main body 11 comprises a cylinder block 20 and a crankcase 30, as shown in FIG. 5 that is an exploded view for showing a part of the engine main body 11 from which the cover members 11a to 11d are removed.

### <<Cylinder Block>>

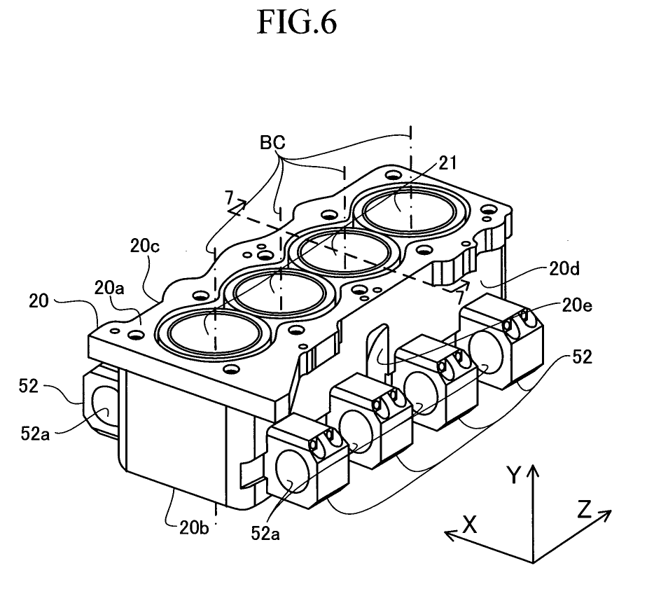

As shown in FIGS. 5 and 6, the cylinder block 20 has generally a rectangular shape having an upper face 20a and a lower face 20b each of which has a generally rectangle shape having short sides parallel to the X-axis and long sides parallel to the Z-axis, and two side faces (sidewall faces) 20c and 20d each of which is perpendicular to the direction of the X-axis (the direction of the short sides). The sidewall face 20c constitutes a part of the left sidewall face (mechanism-disposed-face) OS1. The sidewall face 20d constitutes a part of the right sidewall face (mechanism-disposed-face) OS2.

In this specification, a direction from the upper face 20a toward the lower face 20b of the cylinder block 20 (the negative direction in the Y-axis) will be referred to as a downward direction, while a direction from the lower face 20b toward the upper face 20a of the cylinder block 20 (the positive direction in the Y-axis) will be referred to as an upward direction.

The cylinder block 20 has four cylindrical penetration holes that extend through the cylinder block 20 in a direction orthogonal to the upper face 20a and the lower face 20b (i.e., in the vertical (up-and-down) direction, which will be also referred to as a bore center axis direction). These penetration holes are disposed in a straight line along the long-side direction of the cylinder block 20 (i.e., in the Z-axis direction, sometimes referred to as a cylinder arrangement direction). Each of the penetration holes is referred to as a cylinder bore 21.

One cutout section 20e that is open toward the outside of the cylinder block 20 is formed at each of both sidewall faces 20c and 20d of the cylinder block 20 at the central portion in the cylinder arrangement direction and at the position including the lower end of the cylinder block 20.

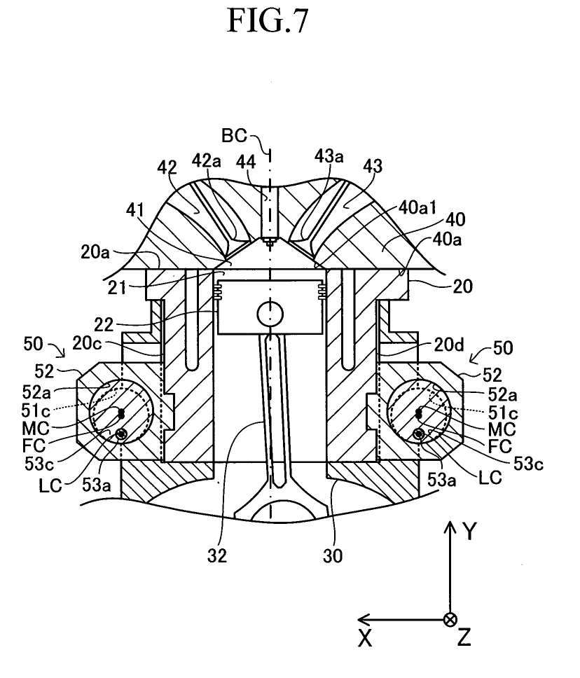

A cylindrical piston 22 is accommodated in each of the cylinder bores 21 as shown in FIG. 7 that is a sectional view showing the internal combustion engine 10 cut in a plane orthogonal to the cylinder arrangement direction and including a line 7-7 passing the center axis (bore center axis) BC of the cylinder bore 21 shown in FIG. 5.

### <<Crankcase>>

The crankcase 30 is fixed to a vehicle body. As shown in FIG. 5, the crankcase 30 has generally a rectangular shape having two side faces (sidewall faces) 30a and 30b each of which is orthogonal to the X-axis direction (short-side direction). The sidewall face 30a constitutes the left sidewall face (mechanism-disposed-face) OS1 together with the sidewall face 20c. The sidewall face 30b constitutes the right sidewall face (mechanism-disposed-face) OS2 together with the sidewall face 20d.

The crankcase 30 rotatably supports a crankshaft 31 and accommodates the crankshaft 31. The crankcase 30 is disposed below the cylinder block 20 in such a manner that the direction of the axis of the crankshaft 31 coincides with (or extends along) the cylinder arrangement direction (the Z-axis direction). Each piston 22 is connected to the crankshaft 31 through a connecting rod 32 as shown in FIG. 7. With this construction, a reciprocating motion of each piston 22 is converted into a rotating motion of the crankshaft 31.

### <<Cylinder Head>>

As shown in FIG. 7, the engine main body 11 includes a cylinder head 40. The cylinder head 40 is fixed onto the upper face 20a of the cylinder block 20 (i.e., at a side of the cylinder block 20 opposite to the crankcase 30) so as not to move relative to the cylinder block 20. Specifically, the cylinder head 40 is fixed to the cylinder block 20 so as to cover opening portions (upper opening portion) of the cylinder bore 21.

The cylinder head 40 has a plurality of concave (or recess) portions 40a1, each of which is open at the face of the cylinder head 40 at the side of the cylinder block 20 (lower face of the cylinder head 40) and each of which corresponds to each of the cylinder bores 21. When the cylinder head 40 is fixed to the cylinder block 20, each of the concave portion 40a1 becomes contiguous with the wall face (bore wall surface) of a corresponding one of the cylinder bores 21. A combustion chamber 41 of each cylinder bore 21 (a chamber 41 of each cylinder) is formed by the concave portion 40a1 provided at the lower face 40a of the cylinder head 40, the bore wall surface, and the face of the piston 22 at the side closer to the cylinder head 40 (i.e., the top face of the piston 22).

In the cylinder head 40, intake port(s) 42 communicating with the combustion chamber 41 and exhaust port(s) 43 communicating with the combustion chamber 41 are formed for each of the cylinders. Furthermore, in the cylinder head 40, an intake valve 42 that opens and closes the intake port 42 and an exhaust valve 43a that opens and closes the exhaust port 43 as well as an ignition plug 44 that generates sparks in the combustion chamber 41 are disposed for each of the individual cylinders. In addition, the cylinder head 40 is provided with a fuel injection valve (injector) not shown. The fuel injection valve injects a fuel in the intake port(s) 42.

### <<Compression Ratio Changing Device>>

The engine main body 11 further includes a compression ratio changing device 50 as shown in FIGS. 5 to 7.

As shown in FIG. 5, the compression ratio changing device 50 includes two sets of a compression ratio changing mechanism 50a and a power transmission mechanism 50b, and an electric motor 50c that serves as a driving source for driving the power transmission mechanism 50b. The power transmission mechanism 50b and the electric motor 50c constitute to driving means.

Two sets of the compression ratio changing mechanism 50a and the power transmission mechanism 50b are provided at the position near the left sidewall face OS1 and at the position near the right sidewall face OS2, respectively, i.e., one set at either position. The compression ratio changing mechanism 50a and the power transmission mechanism 50b at the side of the left sidewall face (mechanism-disposed-face) OS1 are disposed at the position in the vicinity of the mechanism-disposed-face OS1 and are arranged, when the mechanism-disposed-face OS1 is viewed from the front, within the mechanism-disposed-face OS1 (within the end portions that define the mechanism-disposed-face OS1). Further, the compression ratio changing mechanism 50a and the power transmission mechanism 50b at the side of the right sidewall face (mechanism-disposed-face) OS2 are disposed at the position in the vicinity of the mechanism-disposed-face OS2 and are arranged, when the mechanism-disposed-face OS2 is viewed from the front, within the mechanism-disposed-face OS2.

“The compression ratio changing mechanism 50a and the power transmission mechanism 50b at the side of the mechanism-disposed-face OS2” and “the compression ratio changing mechanism 50a and the power transmission mechanism 50b at the side of the mechanism-disposed-face OS1” are symmetrical to each other with respect to an arrangement plane that contains the bore center axes BC of all the cylinders. Therefore, only the compression ratio changing mechanism 50a and the power transmission mechanism 50b at the side of the mechanism-disposed-face OS2 will be described below, as a representative.

### <Compression Ratio Changing Mechanism>

The compression ratio changing mechanism 50a includes a case-side force-receiving section 51, a block-side force-receiving section 52, and a link mechanism 53.

### <Case-Side Force-Receiving Section>

The case-side force-receiving section 51 is provided at the crankcase 30. The case-side force-receiving section 51 is composed of a vertical wall portion 51a having a flat plate shape, and plural cap portions 51b.

The vertical wall portion 51a constitutes an upper portion of the sidewall constituting the sidewall face 30b of the crankcase 30. The vertical wall portion 51a is formed so that, when the cylinder block 20 is disposed on the crankcase 30, the vertical wall portion 51a faces the sidewall face 20d of the cylinder block 20.

The vertical wall portion 51a has plural (four in this example) penetration holes 51a1 that extend in its thickness direction and each of which corresponds to each of the cylinder bores 21 when the cylinder block 20 is disposed on the crankcase 30. Further, the vertical wall portion 51a has a penetration hole 51a3 that extends through the crankcase in its thickness direction at the central portion in the cylinder arrangement direction.

Each of the cap portions 51b is designed so as to be fixed to the vertical wall portion 51a between two adjacent penetration holes (the penetration hole 51a1 and the penetration hole 51a1, or the penetration hole 51a1 and the penetration hole 51a3) formed in the vertical wall portion 51a. Recess portions 51a2 and 51b1 that form cylindrical bearing holes 51c in the cylinder arrangement direction (Z-axis direction) are formed at the vertical wall portion 51a and at the cap portions 51b, respectively, when the cap portions 51b are fixed to the vertical wall portion 51a. Each of the bearing holes 51c is coaxially arranged. The center axes FC of the bearing holes 51c are referred to as case-side force-receiving axes FC in this specification (see FIG. 7).

### <Block-Side Force-Receiving Portion>

The block-side force-receiving portion 52 is made up of plural (four in this example) members each of which corresponds to each of the penetration holes 51a1 of the vertical wall portion 51a. Each of the block-side force-receiving portions 52 is inserted into each of the penetration holes 51a1 of the vertical wall portion 51a, and is fixed to a lower end portion of the sidewall face 20d of the cylinder block 20. That is, each block-side force-receiving portion 52 is provided at the cylinder block 20 so as to protrude outward from the sidewall face 20d of the cylinder block 20.

The length of the block-side force-receiving portions 52 in the vertical direction is shorter than the length of the penetration holes 51a1 of the vertical wall portion 51a in the vertical direction. This construction enables each of the block-side force-receiving portions 52 to move within each of the corresponding penetration holes 51a1 of the vertical wall portion 51a in the vertical direction. That is, the cylinder block 20 is configured to be movable relative to the crankcase 30 in the vertical direction (the direction of the bore center axes).

Each of the block-side force-receiving portions 52 has a cylindrical bearing hole 52a that extends therethrough in the cylinder arrangement direction. The diameter of each of the bearing holes 52a is greater than the diameter of each of the bearing holes 51c. The bearing holes 52a are coaxial with each other. The center axes MC of the bearing holes 52c are also referred to as block-side force-receiving axes MC in the present specification (see FIG. 7).

### <Link Mechanism>

As shown in FIGS. 5 and 7, the link mechanism 53 includes a rod-like eccentric shaft portion 53a, a plurality of stationary cam portions 53b each of which corresponds to each of the bearing holes 51c of the case-side force-receiving portion 51, and a plurality of movable cam portions 53c each of which corresponds to each of the bearing holes 52a of the block-side force-receiving portions 52. The center axis LC of the eccentric shaft portion 53a is referred to as a link axis LC in the present specification (see FIG. 7).

Each stationary cam portion 53b is a cylindrical member having substantially the same diameter as the bearing holes 51c of the case-side force-receiving portion 51. The length of each stationary cam portion 53b in the direction of the axis thereof is substantially the same as the axial length of a corresponding one of the bearing holes 51c of the case-side force-receiving portion 51. Each stationary cam portion 53b has a cylindrical penetration hole that extends therethrough in the direction of the axis at a position that is deviated (eccentric) from the center axis FC of the stationary cam portion 53b, and that has substantially the same diameter as the eccentric shaft portion 53a.

Each movable cam portion 53c is a cylindrical member having substantially the same diameter as the bearing hole 52a of each block-side force-receiving portion 52. The length of each movable cam portion 53c in the direction of the axis thereof is substantially the same as the length of the bearing hole 52a of a corresponding one of the block-side force-receiving portions 52. Each movable cam portion 53c has a cylindrical penetration hole that extends therethrough in the direction of the axis at a position that is eccentric from the center axis MC of the movable cam portion 53c, and that has substantially the same diameter as the eccentric shaft portion 53a.

The stationary cam portions 53b and the movable cam portions 53c are mounted on the eccentric shaft portion 53a in such a manner that the stationary cam portions 53b and the movable cam portions 53c are disposed alternately with each other, their penetration holes are coaxial, and the eccentric shaft portion 53a are inserted into all the penetration holes. The stationary cam portions 53b and the eccentric shaft portion 53a have screw holes (not shown). The stationary cam portions 53b are fixed to the eccentric shaft portion 53a by screws (not shown) that are inserted into the screw holes so that the stationary cam portions 53b do not rotate relative to the eccentric shaft portion 53a and so that all the stationary cam portions 53b are coaxial with each other. On the other hand, the movable cam portions 53c are rotatable relative to the eccentric shaft portion 53a.

The link mechanism 53 is supported by the case-side force-receiving portion 51 and the block-side force-receiving portions 52 so that each stationary cam portion 53b is accommodated in a corresponding one of the bearing holes 51c of the case-side force-receiving portion 51 to be capable of rotating within the bearing hole 51c while in contact with the wall face that defines the bearing hole 51c, and so that each movable cam portion 53c is accommodated in a corresponding one of the bearing holes 52a of the block-side force-receiving portions 52 to be capable of rotating within the bearing hole 52a while in contact with the wall face that defines the bearing hole 52a.

### <Power Transmission Mechanism>

As shown in FIG. 5, the power transmission mechanism 50b includes a worm wheel 54 and a worm 55.

The worm wheel 54 is a helical gear. The worm wheel 54 is fixed to the stationary cam portions 53b so as not to rotate relative to the stationary cam portions 53b, and so as to be coaxial with the stationary cam portions 53b. The worm wheel 54 is inserted into the penetration hole 51a3, and arranged in such a manner that a part thereof is accommodated in a cutout section 20e.

The worm 55 is a worm gear that meshes (engages) with the worm wheel 54. The worm 55 is rotatably supported by the crankcase 30. The worm 55 is driven by the electric motor 50c so as to rotate in a certain direction and a direction reverse to the certain direction.

With this structure, the power transmission mechanism 50b drives the compression ratio changing mechanism 50a through the drive of the worm 55 driven by the electric motor 50c.

Further, as shown in FIGS. 1 to 4, the compression ratio changing mechanism 50a and the power transmission mechanism 50b at the side of the mechanism-disposed-face OS1 are covered up by the cover member 11a when the mechanism-disposed-face OS1 is viewed from the front. Therefore, it can be said that the cover member 11a composes a part of the compression ratio changing mechanism 50a and a part of the power transmission mechanism 50b.

The compression ratio changing mechanism 50a and the power transmission mechanism 50b at the side of the mechanism-disposed-face OS2 are covered up by the cover member 11b when the mechanism-disposed-face OS2 is viewed from the front. Therefore, it can be said that the cover member 11b composes a part of the compression ratio changing mechanism 50a and a part of the power transmission mechanism 50b.

### <Intake-System-Constructing-Section>

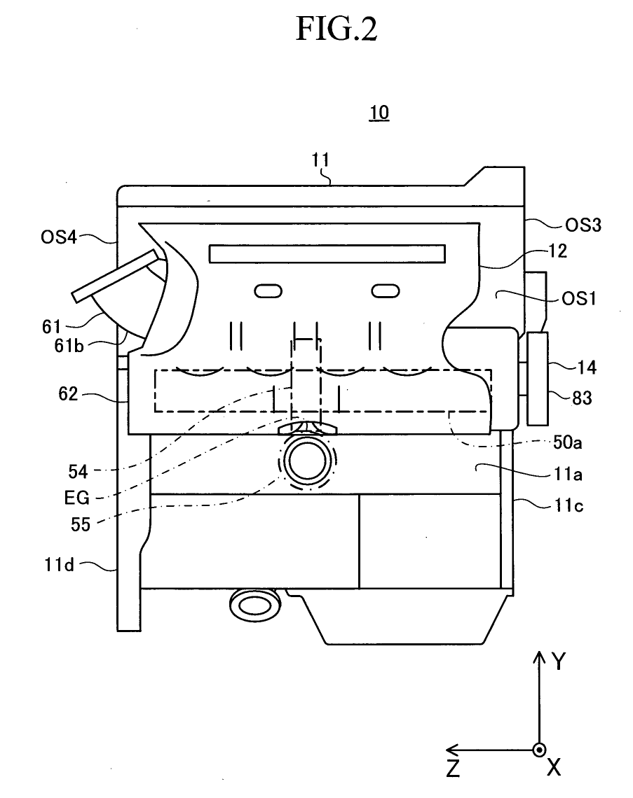

The intake-system-constructing-section 12 includes an intake manifold 61 and a designed cover (or an ornamental cover) 62 as shown in FIGS. 1 and 2.

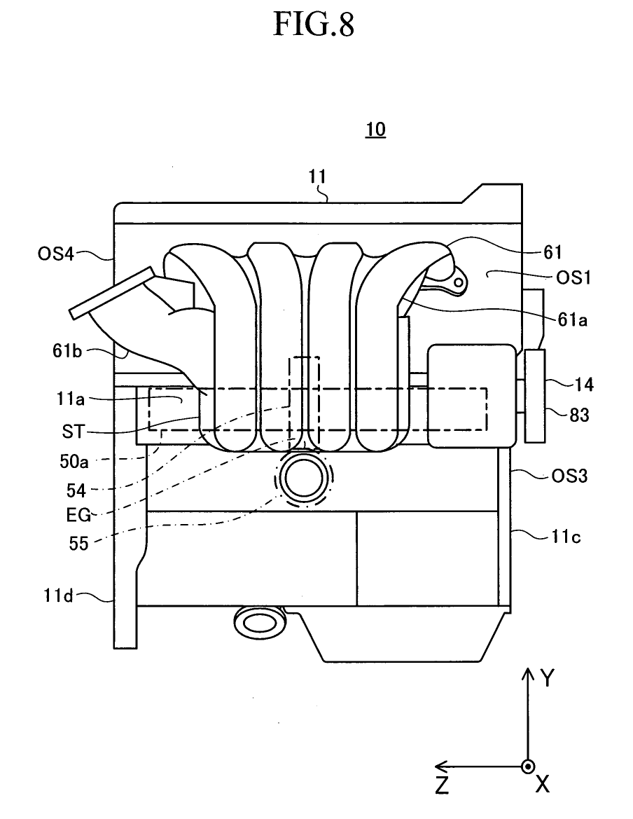

The intake manifold 61 constitutes a part of the intake-system-constructing-member that constructs an intake system for introducing air in the internal combustion engine 10. As shown in FIG. 8 showing the internal combustion engine 10 from which the designed cover 62 is removed, the intake manifold 61 is composed of branch portions 61a that form plural independent passages, each of which communicates with each of the intake ports 42 of the cylinders, and a base portion 61b that forms a single passage communicating with all of the plural passages. The base portion 61b includes a surge tank ST. The base portion 61b is coupled to an unillustrated intake pipe.

The intake manifold 61 extends to the portion slightly lower than a meshing portion EG where the worm wheel 54 and the worm 55 are meshed with each other, when the left sidewall face OS1 is viewed from the front (i.e., in this embodiment, when the internal combustion engine 10 is viewed from the direction orthogonal to the arrangement plane of the bore center axis). Specifically, the intake manifold 61 covers the meshing portion EG when the left sidewall face OS1 is viewed from the front. Therefore, it can be said that the intake manifold 61 constitutes a part of a noise shielding member.

The designed cover 62 is made of a resin. As shown in FIG. 2, the designed cover 62 is formed so as to cover almost the whole intake manifold 61 when the left sidewall face OS1 is viewed from the front. The lower part of the designed cover 62 extends in the cylinder arrangement direction so as to cover the portion of the compression ratio changing mechanism 50a, the portion being not covered by the intake manifold 61, when the left sidewall face OS1 is viewed from the front. Therefore, it can be said that the designed cover 62 forms a part of the noise shielding member.

### <Exhaust-System-Constructing-Section>

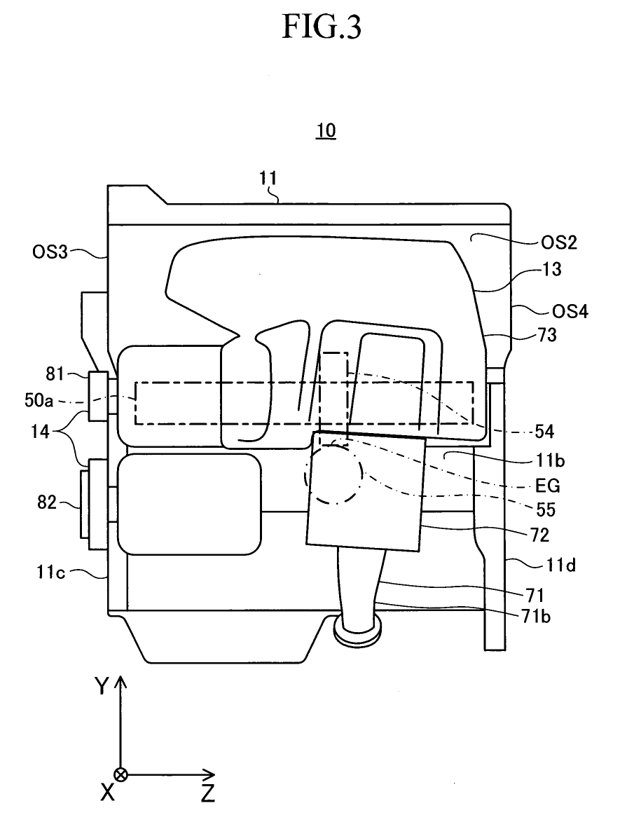

As shown in FIGS. 1 and 3, the exhaust-system-constructing-section 13 includes an exhaust manifold 71, a heat insulator plate 72, and a heat-insulating cover 73.

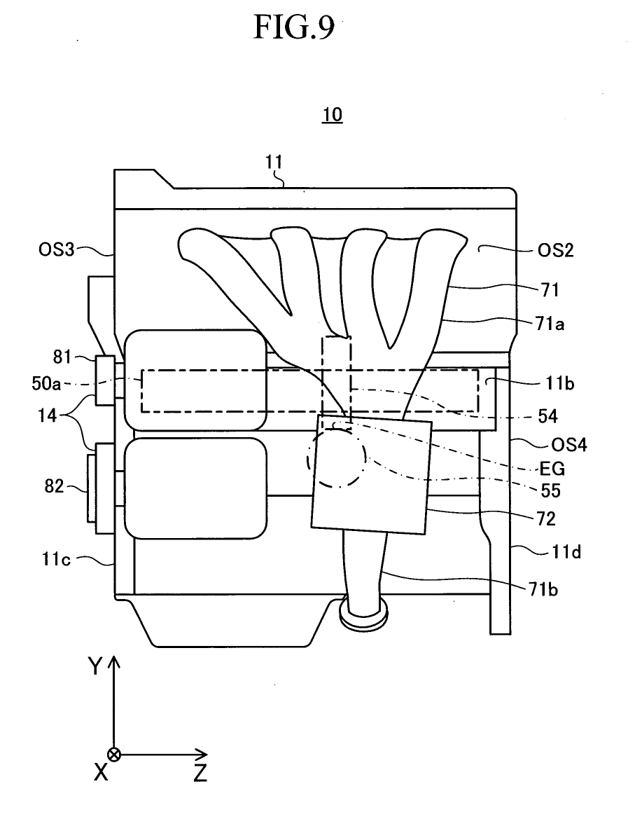

The exhaust manifold 71 constitutes a part of the exhaust-system-constructing-section that constructs an exhaust system for exhausting an exhaust gas from the internal combustion engine 10. As shown in FIG. 9 showing the internal combustion engine 10 from which the heat-insulating cover 73 is removed, the exhaust manifold 71 is composed of branch portions 71a that form plural independent passages, each of which communicates with each of the exhaust ports 43 of the respective cylinders and a base portion 71b that forms a single passage communicating with all of the plural passages. An unillustrated catalyst is disposed at the base portion 71b. The base portion 71b is coupled to an unillustrated exhaust pipe.

The heat insulator plate 72 constitutes a part of the exhaust-system-constructing-section. The heat insulator plate 72 is a metallic heat insulator. The heat insulator plate 72 is formed so as to cover a portion of the base portion 71b where the catalyst is disposed.

The exhaust manifold 71 and the heat insulator plate 72 are formed so as to cover a meshing portion EG where the worm wheel 54 and the worm 55 are meshed with each other, when the right sidewall face OS2 is viewed from the front (i.e., in this embodiment, when the internal combustion engine 10 is viewed from the direction orthogonal to the arrangement plane of the bore center axis).

The heat-insulating cover 73 is made of a metal (e.g., iron, aluminum, etc.). As shown in FIG. 3, the heat-insulating cover 73 is formed to cover a part of the exhaust manifold 71 and the heat insulator plate 72, when the right sidewall face OS2 is viewed from the front. The lower part of the heat-insulating cover 72 extends in the cylinder arrangement direction so as to cover a portion of the compression ratio changing mechanism 50a, the portion being not covered by the exhaust manifold 71 and the heat insulator plate 72, when the right sidewall face OS2 is viewed from the front. Therefore, it can be said that the heat-insulating cover 73 forms a part of the noise shielding member.

### <Accessories Section>

As shown in FIGS. 1, 8 and 9, the accessories section 14 includes an alternator 81, a compressor 82 for an air conditioner, and a hydraulic pump 83 for a power steering device.

Each of the alternator 81, the compressor 82, and the hydraulic pump 83 is coupled to a crankshaft 31 serving as an output shaft of the internal combustion engine 10 through a pulley PL and an unillustrated belt. They are devices (accessories) configured to be capable of being driven when the crankshaft 31 is rotationally driven. The pulley PL is fixed to an end portion of the crankshaft 31 at the side of the front sidewall face OS3, as shown in FIG. 4.

The alternator 81 generates electric power when it is driven, and charges an unillustrated battery by the generated electric power. As shown in FIG. 9, the alternator 81 is fixed to the right sidewall face OS2 at the position of the front sidewall face OS3 so as to cover a portion of the compression ratio changing mechanism 50a, the portion being not covered by the exhaust-system-constructing-section 13, when the right sidewall face OS2 is viewed from the front. Therefore, it can be said that the alternator 81 constitutes a part of the noise shielding member.

The compressor 82 compresses a refrigerant of the air conditioner when it is driven. The compressor 82 is fixed to the right sidewall face OS2 below the alternator 81 so as to be adjacent to the alternator 81.

The hydraulic pump 83 compresses a working fluid of the power steering device, when it is driven. As shown in FIG. 8, the hydraulic pump 83 is fixed to the left sidewall face OS1 at the position of the front sidewall face OS3 so as to cover a portion of the compression ratio changing mechanism 50a, the portion being not covered by the intake-system-constructing-section 12, when the left sidewall face OS1 is viewed from the front. Therefore, it can be said that the hydraulic pump 83 constitutes a part of the noise shielding member.

### <Operation of Compression Ratio Changing Device>

Next, the operation of the compression ratio changing device 50 having the configuration described above will be explained.

At the outset, a case will be explained in which the compression ratio changing device 50 changes the compression ratio of the internal combustion engine 10 from the minimum ratio to the maximum ratio. The operation of the compression ratio changing mechanism 50a at the side of the mechanism-disposed-face OS1 and the operation of the compression ratio changing mechanism 50b at the side of the mechanism-disposed-face OS2 are symmetrical with respect to the arrangement plane of the bore center axis. Accordingly, the operation of the compression ratio changing mechanism 50a at the side of the mechanism-disposed-face OS1 will mainly be explained below.

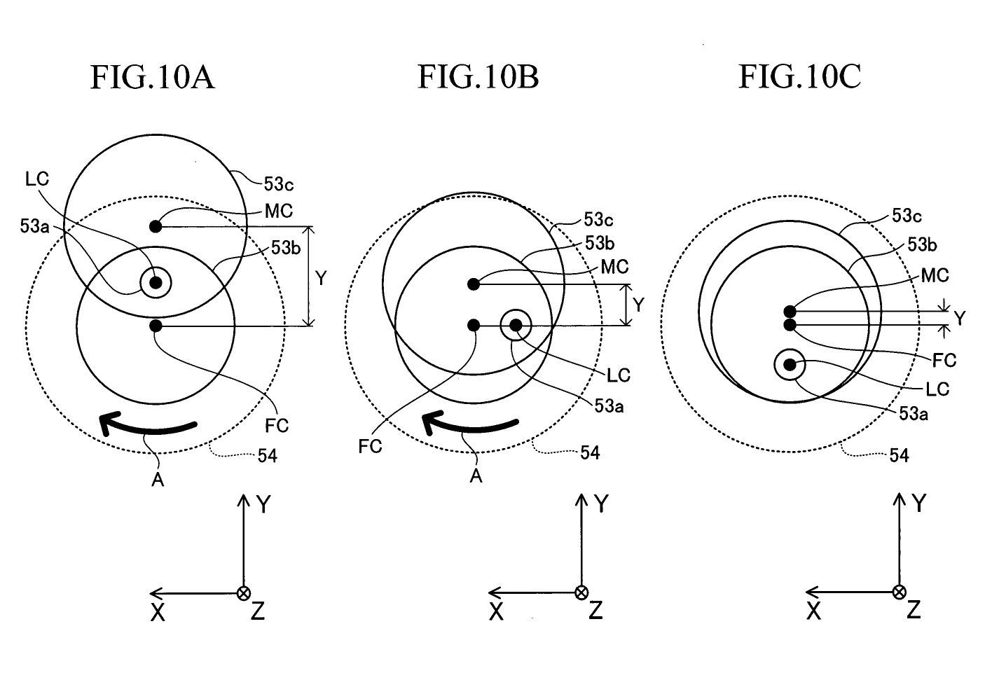

When the compression ratio of the internal combustion engine 10 is the minimum ratio, the case-side force-receiving axis FC, the link axis LC and the block-side force-receiving axis MC are arranged on the same straight line in this order, wherein the distance Y between the case-side force-receiving axis FC and the block-side force-receiving axis MC in the vertical direction becomes the longest, as shown in FIG. 10 (FIG. 10A) that illustrates an enlarged view of the link mechanism 53 at the side of the mechanism-disposed-face OS1 in case where the internal combustion engine 10 is viewed in the direction that is parallel to the cylinder arrangement direction and that directs from the front sidewall face OS3 toward the rear sidewall face OS4 (positive direction of the Z-axis). Therefore, since the distance between the crankcase 30 and the cylinder block 20 in the vertical direction becomes the longest, the compression ratio of the internal combustion engine 10 becomes the minimum ratio.

With this state, the compression ratio changing device 50 drives the electric motor 50c in such a manner that the worm wheel 54 fixed to the link mechanism 53 at the side of the mechanism-disposed-face OS1 is driven to rotate in the clockwise direction (i.e., in the direction shown by an arrow A). With this operation, the link axis LC at the side of the mechanism-disposed-face OS1 rotates in the clockwise direction around the case-side force-receiving axis FC defined as a center of the rotation (i.e., about the case-side force-receiving axis FC). In this case, all of the movable cam portions 53c cannot move in the side-to-side direction due to the rigidity of the cylinder block 20.

Accordingly, the movable cam portions 53c at the side of the mechanism-disposed-face OS1 rotate in the bearing holes 52a in the counterclockwise direction as being in contact with the wall face that forms the bearing holes 52a of the block-side force-receiving portion 52, thereby pressing down the block-side force-receiving portion 52. Then, by continuing the rotational drive of the worm wheel 54, the compression ratio changing device 50 reaches the state in which the link axis LC is arranged side by side with the case-side force-receiving axis FC, the link axis LC being located at a position inwardly closer to the engine main body 11 than the case-side force-receiving axis FC as shown in FIG. 10B.

In the state shown in FIG. 10B, the distance Y between the case-side force-receiving axis FC and the block-side force-receiving axis MC in the vertical direction becomes shorter than the distance Y in the case shown in FIG. 10A. Therefore, the distance between the crankcase 30 and the cylinder block 20 in the vertical direction becomes also shorter. Thus, the compression ratio of the internal combustion engine 10 becomes higher than that of the case shown in FIG. 10A.

Further, by continuing the rotational drive of the worm wheel 54, the link axis LC at the side of the mechanism-disposed-face OS1 rotates in the clockwise direction about the case-side force-receiving axis FC. With this operation, the movable cam portions 53c at the side of the mechanism-disposed-face OS1 rotate in the bearing holes 52a in the clockwise direction as being in contact with the wall face that forms the bearing holes 52a of the block-side force-receiving portion 52, thereby pressing down the block-side force-receiving portion 52. Then, the compression ratio changing device 50 reaches the state shown in FIG. 10C.

In the state shown in FIG. 10C, the link axis LC, the case-side force-receiving axis FC and the block-side force-receiving axis MC are arranged on the same straight line in this order, so that the distance Y between the case-side force-receiving axis FC and the block-side force-receiving axis MC in the vertical direction becomes the shortest (i.e., becomes shorter than the distance shown in FIG. 10A and the distance shown in FIG. 10B). Therefore, the distance between the crankcase 30 and the cylinder block 20 in the vertical direction also becomes the shortest. Therefore, the compression ratio of the internal combustion engine 10 becomes the maximum ratio.

In this manner, the compression ratio of the internal combustion engine 10 changes from the minimum ratio to the maximum ratio.

Next, a case will be explained in which the compression ratio changing device 50 changes the compression ratio of the internal combustion engine 10 from the maximum ratio to the minimum ratio.

In this case, the compression ratio changing device 50 drives the electric motor 50c in such a manner that the worm wheel 54 fixed to the link mechanism 53 at the side of the mechanism-disposed-face OS1 is driven to rotate in the counterclockwise direction in the state shown in FIG. 10C. With this operation, the link axis LC at the side of the mechanism-disposed-face OS1 rotates in the counterclockwise direction about the case-side force-receiving axis FC.

Accordingly, the movable cam portions 53c at the side of the mechanism-disposed-face OS1 rotate in the bearing holes 52a in the counterclockwise direction as being in contact with the wall face that forms the bearing holes 52a of the block-side force-receiving portion 52, thereby pressing up the block-side force-receiving portion 52. Therefore, by continuing the rotational drive of the worm wheel 54, the compression ratio changing device 50 reaches the state shown in FIG. 10B, and then, reaches the state shown in FIG. 10A by further continuing the rotational drive.

In this manner, the compression ratio of the internal combustion engine 10 changes from the maximum ratio to the minimum ratio.

In the internal combustion engine 10 according to the aforesaid embodiment, when the compression ratio of the internal combustion engine 10 is changed by driving the power transmission mechanism 50b, the worm wheel 54 and the worm 55 strike against each other at the meshing portion EG, and thus a coarse large sound (noise) might be generated.

Further, even in the state in which the compression ratio of the internal combustion engine 10 is maintained to be constant, the noise may be generated at the meshing portion EG as described below, because the mixture gas is burnt in the combustion chamber 41.

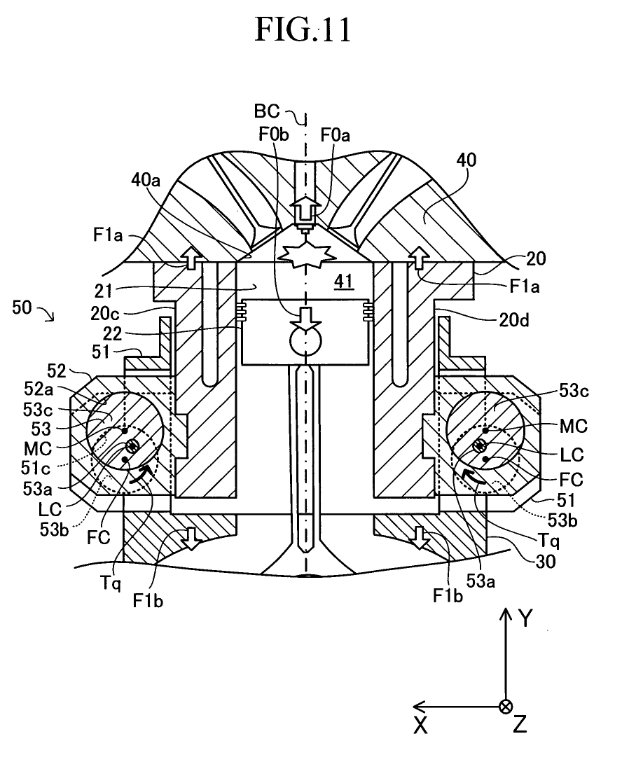

When the mixture gas formed in the combustion chamber 41 is burnt, the pressure of the gas in the combustion chamber (combustion pressure) becomes extremely high. As shown in FIG. 11, this combustion pressure pushes upward the lower face 40a of the cylinder head 40 with a force F0a, while pushes downward the top face of the piston 22 with a force F0b. Thus, a force F1a directing upward is applied to the cylinder block 20 to which the cylinder head 40 is fixed, while a force F1b directing downward is applied to the crankcase 30 that supports the crankshaft 31 coupled to the piston 22.

As a result, a force for separating the cylinder block 20 from the crankcase 30 is applied to the compression ratio changing device 50. Specifically, a torque Tq, which attempts to rotate the link axis LC at the side of the mechanism-disposed-face OS1 in the counterclockwise direction about the case-side force-receiving axis FC, is applied to the stationary cam portions 53b at the side of the mechanism-disposed-face OS1. Further, a torque Tq, which attempts to rotate the link axis LC at the side of the mechanism-disposed-face OS2 in the clockwise direction about the case-side force-receiving axis FC, is applied to the stationary cam portions 53b at the side of the mechanism-disposed-face OS2.

The torque Tq changes depending on the change in the combustion pressure. Therefore, a relatively large force from the worm wheel 54 to drive the worm 55 is periodically generated at the meshing portion EG where the worm wheel 54 and the worm 55 are meshed with each other. Consequently, the worm wheel 54 and the worm 55 strike against each other at the meshing portion EG, and thus the noise is generated.

In the present embodiment, as described above, the meshing portion EG at the side of the mechanism-disposed-face OS1 is covered by the intake manifold 61, the designed cover 62, and the hydraulic pump 83 (i.e. the noise shielding member), when the mechanism-disposed-face OS1 is viewed from the front. Further, the meshing portion EG at the side of the mechanism-disposed-face OS2 is covered by the exhaust manifold 71, the heat insulator plate 72, the heat-insulating cover 73, and the alternator 81 (i.e., the noise shielding member), when the mechanism-disposed-face OS2 is viewed from the front.

Accordingly, the noise generated by the power transmission mechanism 50b at the meshing portion EG is attenuated by the noise shielding member, and propagated to the outside of the internal combustion engine 10. Consequently, the noise that can be heard at the outside of the internal combustion engine 10 is reduced, compared to the case in which the power transmission mechanism 50b is not covered by the noise shielding member.

Moreover, according to the present embodiment, the whole of the power transmission mechanism 50b and the compression ratio changing mechanism 50a at the side of the mechanism-disposed-face OS1 is covered up by the intake manifold 61, the designed cover 62, and the hydraulic pump 83 (the noise shielding member), when the mechanism-disposed-face OS1 is viewed from the front. Furthermore, the whole of the power transmission mechanism 50b and the compression ratio changing mechanism 50a at the side of the mechanism-disposed-face OS2 is covered up by the exhaust manifold 71, the heat insulator plate 72, the heat-insulating cover 73, and the alternator 81 (the noise shielding member), when the mechanism-disposed-face OS2 is viewed from the front.

Accordingly, the noise generated at each of the power transmission mechanism 50b and the compression ratio changing mechanism 50a is attenuated by the noise shielding member. Consequently, the noise that can be heard at the outside of the internal combustion engine 10 is reduced, compared to the case in which the whole of the power transmission mechanism 50b and the compression ratio changing mechanism 50a is not covered by the noise shielding member.

The present invention is not limited to the embodiment described above, and various modifications are possible without departing from the scope of the present invention. For example, in the present embodiment, an acoustic insulator material and/or a sound insulating material may be filled in the space between the left sidewall face OS1 of the engine main body 11 and the intake-system-constructing-section 12 and/or in the space between the right sidewall face OS2 of the engine main body 11 and the exhaust-system-constructing-section 13.

In the present embodiment described above, the noise shielding member is composed of the intake manifold 61, the designed cover 62, the exhaust manifold 71, the heat insulator plate 72, the heat-insulating cover 73, the alternator 81, and the hydraulic pump 83. However, the noise shielding member may be composed of one or some of these members.

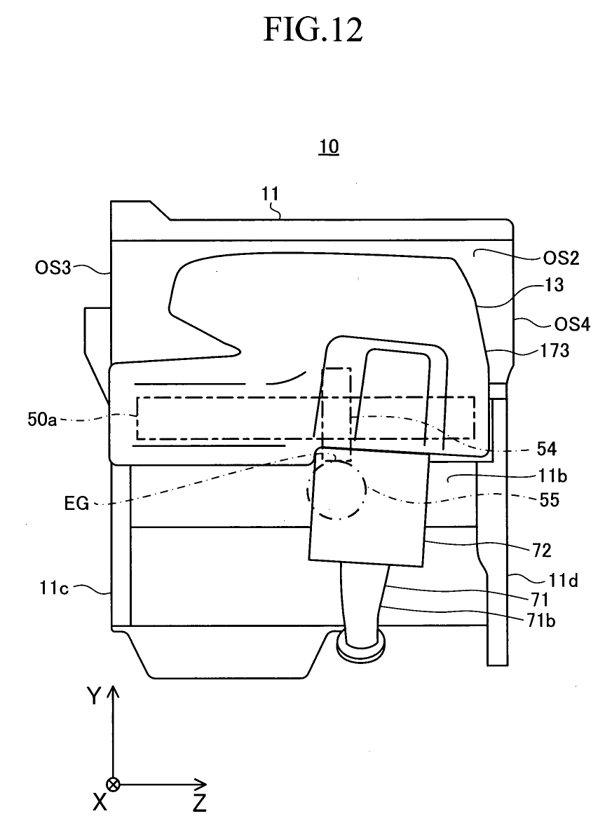

For example, as shown in FIG. 12, if the accessories are not fixed to the right sidewall face OS2 of the internal combustion engine 10, it is preferable that the lower part of the heat-insulating cover 173 extend in the cylinder arrangement direction to cover the whole of the portion of the compression ratio changing mechanism 50a, the portion being not covered by the exhaust manifold 71 and the heat insulator plate 72.

Although the present embodiment described above is configured such that the whole of the power transmission mechanism 50b and the compression ratio changing mechanism 50a is covered, it may be configured such that only a part of the power transmission mechanism 50b, or a part of the power transmission mechanism 50b and a part of the compression ratio changing mechanism 50a are covered.

In the present embodiment described above, the compression ratio changing mechanism 50a moves the cylinder block 20 relative to the crankcase 30 in the direction of the bore center axis so as to change the compression ratio. However, the compression ratio changing mechanism may be configured in such a manner that the crankcase 30 is moved relative to the cylinder block 20 for changing the compression ratio.

In addition, the compression ratio changing mechanism 50a may be configured in such a manner that it tilts the cylinder block 20 relative to the crankcase 30 so as to change the compression ratio. Additionally, the compression ratio changing mechanism 50a may be configured in such a manner that it changes the distance between the top face of the piston 22 when positioned at the top dead center and the crankshaft 31 so as to change the compression ratio, and/or the distance between the top face of the piston 22 when positioned at the bottom dead center and the crankshaft 31 so as to change the compression ratio.

1. A variable compression ratio internal combustion engine comprising:
a compression ratio changing mechanism that is driven to change a compression ratio of the engine;
driving means including a power transmission mechanism and a power source that drives the power transmission mechanism, the power transmission mechanism being driven to drive the compression ratio changing mechanism, the power transmission mechanism being disposed at a position in the vicinity of a mechanism-disposed-face which is composed of at least one of a side wall face of a cylinder block and a side wall face of a crankcase, and the power transmission mechanism being arranged within the mechanism-disposed-face when the mechanism-disposed-face is viewed from the front; and
a noise shielding member that is arranged so as to cover at least a part of the power transmission mechanism, when the mechanism-disposed-face is viewed from the front.

2. A variable compression ratio internal combustion engine according to claim 1, wherein
the power transmission mechanism includes a pair of gears that are meshed with each other; and
the noise shielding member is disposed so as to cover a meshing portion where the pair of gears mesh with each other, when the mechanism-disposed-face is viewed from the front.

3. A variable compression ratio internal combustion engine according to claim 1 or claim 2, wherein
the noise shielding member is configured to cover the whole of the power transmission mechanism and the compression ratio changing mechanism, when the mechanism-disposed-face is viewed from the front.

4. A variable compression ratio internal combustion engine according to any one of claims 1 to 3, wherein
the noise shielding member includes at least one of an intake-system-constructing-member that constructs an intake system for introducing air into the variable compression ratio internal combustion engine, an exhaust-system-constructing-member that constructs an exhaust system for exhausting exhaust gas from the variable compression ratio internal combustion engine, and accessories that are devices configured to be capable of being driven by an output shaft of the variable compression ratio internal combustion engine.

5. A variable compression ratio internal combustion engine according to claim 4, wherein
the noise shielding member includes a designed cover that covers at least a part of the intake-system-constructing-member, when the intake-system-constructing-member and the mechanism-disposed-face are viewed from the front.

6. A variable compression ratio internal combustion engine according to claim 4 or claim 5, wherein
the noise shielding member includes a heat-insulating cover that covers at least a part of the exhaust-system-constructing-member, when the exhaust-system-constructing-member and the mechanism-disposed-face are viewed from the front.
